(19) United States
(12) Patent Application Publication
(10) Pub. No.: US 2012/0256996 A1
(43) Pub. Date: Oct. 11, 2012

(54) Method for Actuating a Digital Printing Unit, and Digital Printing Press

(75) Inventor: Stephan Schultze, Lohr-Wombach (DE)

(73) Assignee: Robert Bosch GmbH, Stuttgart (DE)

(21) Appl. No.: 13/501,604

(22) PCT Filed: Sep. 23, 2010
(86) PCT No.: PCT/EP2010/005821

§ 371 Date: Jun. 29, 2012

(30) Foreign Application Priority Data
Oct. 16, 2009 (DE) 10 2009 049 543.6
Sep. 7, 2010 (DE) 10 2010 044 645.9

(51) Int. Cl. B41J 2/00

(52) U.S. Cl. 347/110

(57) ABSTRACT

A method for actuating at least one digital printing unit of a digital printing press, includes at least one driven transport device and an associated movement control device. The at least one digital printing unit is connected to the movement control device via a data connection. Values of variables characterizing the transport are transmitted digitally from the movement control device via the data connection to the at least one digital printing unit, so as to be used for controlling the printing process in the at least one digital printing unit.

### The present invention relates to a method for actuating a digital printing unit and to a digital printing press according to the preambles of the independent patent claims.

### PRIOR ART

In printing technology, what are known as analog printing units are mainly used, in which the printing image is present as a complete original, for example in the form of a printing plate or a stereotype plate. In addition, however, in recent times what are known as digital printing units have increasingly been used, in which the printing image is produced in a computing unit and then applied to the material or an image transfer cylinder, for example in the inkjet printing method or in the electrophotographic printing method. In digital printing methods there is in particular the difficulty of synchronizing the start and the internal grid, for example printing lines, of the printing image with the web transport in order to ensure maintenance of register.

In the prior art, real incremental encoders or incremental encoder emulators are used for this purpose. Usually, an encoder resolution is chosen here which can be converted in a straightforward manner into the processing internal to the printing unit. If a printing unit is operated with 600 dpi (dots per inch), for example, it is expedient if the encoder or the encoder emulation is a multiple or, as usually constructed, a divisor of 600. This means that for each inch of feed speed of the product web or material sheet a corresponding number of increments is expected at the encoder input of the digital printing unit. In the case of 600 dpi, for example, an encoder resolution of 15 increments per inch may be chosen. In a typical encoder evaluation within a printing unit, this can then be increased by what is known as fourfold evaluation to 60 increments per inch. An increase to 600 increments per inch is then typically carried out by means of a phase-locked loop (PLL).

Digital printing units coupled to the web transport via incremental encoders are described, for example, in DE 10 2006 009 773 A1 or EP 1 157 837 A2.

However, this solution has a number of disadvantages. Firstly, it is to be recorded that both the position of the printing image on the printing material and also the internal screened make-up of the printing image depend on the encoder resolution. In addition, the evaluation of the encoder input is afflicted by jitter, since this is often carried out in a time-discrete manner. The evaluation of the encoder input is moreover afflicted by noise. Filtering for improving the encoder signal leads to dead times or delays in the overall system. In addition, it is not always possible to provide an encoder or an encoder emulation with a resolution suitable for the printing unit. In this case, the accuracy is further impaired. In addition, mechanical faults on the web transport in the case of a real encoder or faults in an encoder connection lead to defects in the printed image. Finally, a real incremental encoder or an encoder emulation, together with the encoder evaluation needed in the printing unit, is costly.

It is therefore desirable to couple a digital printing unit more accurately and in particular also more simply to the transport of the product web or the material sheet.

### DISCLOSURE OF THE INVENTION

According to the invention, a method for actuating a digital printing unit and a digital printing press having the features of the independent patent claims are proposed. Advantageous refinements are the subject matter of the subclaims and of the following description.

### ADVANTAGES OF THE INVENTION

The invention is based substantially on the finding that more accurate and nevertheless simpler coupling of a digital printing unit to the web transport can be provided if an—expediently shaftless—transport device is used and the printing unit is attached directly to the motion control device (motion control, PLC), in particular via a real-time bus connection. Conventional, indirect and therefore only inaccurate coupling via incremental encoder signals is avoided. The printing operation, i.e. the imaging of the cylinder in the case of an electrophotographic method or application of ink in an inkjet method, is controlled directly by means of the digitally transmitted values.

Expediently, the digital printing unit is connected directly to the motion control and/or the drives and/or the communication system (e.g. Fieldbus). Direct connection means that no (binary) incremental encoder information is transmitted from the movement control system to the digital printing unit; instead numerical values and optionally also further (binary) information. These numerical values can be, for example, a machine speed, a master shaft position, an acceleration, a jolt and so on. Further information can be used, for example, for transmitting status information (to signal acceleration operations, control the imaging from the PLC, and so on).

It is advantageous here that the resolution of the information transmitted can be chosen to be substantially higher than in the case of encoder evaluation. The information transmitted is not afflicted by jitter or noise but is digitally accurate.

In digital printing technology—quite by contrast to the conventional analog printing technology—the principle applies that the format length does not coincide with the master shaft movement. A digital printing unit is usually supplied with pulses at the spacing of the printing screen, for example a printing line, in order to identify the printing time of the next screen element. For this reason, in digital printing technology, it has also been for a long time an established practice to connect printing units by way of pulses. The invention now deliberately turns away from this tradition. By means of a direct, digital connection, considerably more accurate position data can be received from the printing unit, which then determines the printing times for the screen elements internally on the basis of this position data.

Cyclic transmission offers the advantage of more accurate extrapolations and interpolations. By using the transmission of position data at known and therefore predeterminable, in particular equidistant, times, the printing unit or the control device thereof receiving the position data can output a printing image with little delay. In real-time communication systems, information is typically transmitted in what are known as communication cycles. It is normally known at what time (within the communication cycle) the transmitted data is valid (in the same cycle), was valid (in preceding cycles) or will become valid (in following cycles). In this way, highly accurate interpolations can be carried out in the digital printing unit. By means of the knowledge of the highly accurate cycle time of the communication cycle and actual value processing times within the communication cycle, better data processing can also be achieved in the digital printing unit, for example by means of a PLL, for the purpose of imaging (e.g. print head actuation). A further advantage of real-time communication systems with cyclic transmission is the virtually jitter-free clocking of the (step-up) PLL by means of the information from the transmission cycles (e.g. synchronization information from the SERCOS III real-time communication system).

The direct connection additionally advantageously offers the possibility of a diagnostic connection. In addition, the digital printing unit can be controlled by the motion control device, so that the previously existing necessity for a higher-order control device is dispensed with.

Further advantages and refinements of the invention can be gathered from the description and the appended drawing.

It goes without saying that the features mentioned above and those still to be explained below can be used not only in the respectively specified combination but also in other combinations or on their own without departing from the scope of the present invention.

The invention is illustrated schematically in the drawing by using an exemplary embodiment and will be described extensively below with reference to the drawing.

### DESCRIPTION OF THE FIGURE

FIG. 1 shows a schematic illustration of a preferred embodiment of a processing machine according to the invention constructed as a printing press.

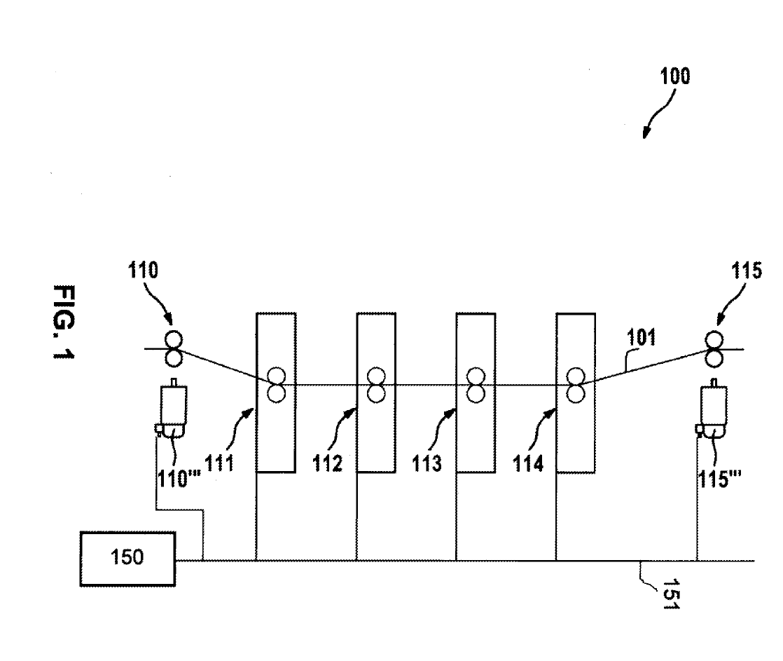

In FIG. 1, a preferred embodiment of a digital printing press according to the invention is illustrated schematically and designated overall by 100. Printing material, for example paper 101, is fed to the press via an infeed 110. The paper 101 is guided through digital printing units 111, 112, 113, 114 and printed and output again by an outfeed 115.

The infeed 110 has a drive 110′″, and the outfeed 115 has a drive 115′″, which are in each case connected via a data connection 151 to a (transport) control device 150, for example a PLC. The data connection 151 can in particular be implemented as a real-time fieldbus connection, for example as a SERCOS III connection. Via the data connection 151, for example, a master shaft position is transmitted digitally to the infeed 110 and the outfeed 115.

The digital printing units 111 to 114 can operate, for example, on the basis of an inkjet principle or electrophotographically. The printing units transfer the printing image, for example line by line, to the material 101. However, it is important that the digital printing units 111 to 114 are likewise connected to the communication structure or data connection 151, so that they receive digital values from the control device 150. In a real-time-capable communication system, the data is typically transmitted cyclically, so that for each value transmitted there is also accurate time information present about the validity of the value. In addition, the transmission of value and time information can also be carried out in pairs. Thus, in the a interpolations can be carried out in order, for example, to be able to carry out line by line digital printing accurately. The printing operation, i.e. the imaging and the application of the ink, is controlled by means of the transmitted values. No (incremental) encoder impulses are used for this purpose.

1. A method for actuating at least one digital printing unit of a digital printing press having at least one driven transport device and an associated motion control device, the method comprising:
connecting the at least one digital printing unit to the motion control device via a data connection;
digitally transmitting values of variables characterizing the transport from the motion control device via the data connection to the at least one digital printing unit; and
using the values of variables characterizing the transport to control the printing operation in the at least one digital printing unit.

2. The method as claimed in claim 1, wherein no encoder impulses are transmitted to the at least one digital printing unit in order to control the printing operation.

3. The method as claimed in claim 1, wherein the values are transmitted in real time.

4. The method as claimed in claim 1, wherein the values are transmitted cyclically.

5. The method as claimed in claim 1, wherein the variable characterizing the transport is a machine speed, a master shaft position, an acceleration and/or a jolt.

6. The method as claimed in claim 1, wherein further information is transmitted via the data connection.

7. A digital printing press comprising:
at least one driven transport device with an associated motion control device;
at least one digital printing unit;
a data connection from the motion control device to the at least one digital printing unit for the digital transmission of values of variables characterizing the transport to control the printing operation in the at least one digital printing unit.

8. The digital printing press as claimed in claim 7, wherein the data connection is formed as a real-time connection.

9. The digital printing press as claimed in claim 7, wherein the data connection is formed as a fieldbus connection.

10. The digital printing press as claimed in claim 7, wherein the data connection is formed as a SERCOS connection.
